(19) United States
(12) Patent Application Publication
(10) Pub. No.: US 2005/0115091 A1
(43) Pub. Date: Jun. 2, 2005

(54) Carpenter's tool

(76) Inventor: Rick Harris, Gower, MO (US)

Correspondence Address: HOVEY WILLIAMS LLP;Suite 400, 2405 Grand, Kansas City, MO, 64108, US

(21) Appl. No.: 10/951,157

(22) Filed: Sep. 27, 2004

Related U.S. Application Data
(60) Provisional application No. 60/526,367, filed on Dec. 2, 2003.

(51) Int. Cl. B43L 7/10

(52) U.S. Cl. 33/461

(57) ABSTRACT

A measuring device (10) comprises an elongated base (12) with a groove (24) therein; a first arm (30) and a second arm (40) adjustably secured to the base (12); a first cross member (50) adjustably secured to the first arm (30); and a second cross member (58) adjustably secured to the second arm (40). The groove (24) in the base (12) mates with and guides the movement of the first arm (30) and the second arm (40) relative to the base (12) so that the arms (30,40) are slidably adjustable to allow a length of the device (10) to conform to a length of an area to be measured. The first cross member (50) is slidably and pivotally secured to the first arm (30) to conform to an angle and a depth of a first edge the area to be measured. The second cross member (58) is slidably and pivotally secured to the second arm (40) to conform to an angle and a depth of a second edge of the area to be measured.

### RELATED APPLICATIONS

The present application is a nonprovisional patent application and claims priority benefit, with regard to all common subject matter, of earlier-filed U.S. provisional patent application titled “CARPENTER'S TOOL,” Ser. No. 60/526,367, filed Dec. 2, 2003. The identified earlier-filed provisional application is hereby incorporated by reference into the present application.

### BACKGROUND OF THE INVENTION

1. Field of the Invention

The present invention relates to a tool for measuring a size and shape of an area. More particularly, the present invention relates to a carpenter's tool that adjusts to conform to a size and a shape of an area such as a window sill and retains the size and shape as a pattern for cutting a material to the same size and shape as the area.

2. Description of Prior Art

Carpentry requires frequent measuring to determine the necessary length, width, and/or height of boards or other material used in construction. Often, a board or other material needs to be cut to a specific size and shape to cover or fill a particular area. For example, a board may need to be cut to fit within a window sill; a piece of linoleum may need to be cut to cover a portion of floor; or a piece of sheet rock may need to be cut to cover a particular area of a wall.

Cutting a material to the proper size and shape to cover a particular surface area presents several challenges. First, acquiring the proper dimensions and transferring those dimensions to the material is time consuming and often difficult to do with a high degree of precision. Second, the area to be covered often includes arbitrarily angled and/or curved edges, in which case a user must try to cut the material to replicate the angled and/or curved edges.

Prior art measuring tools present undesirable limitations when used to prepare a material to fit within such an area. Tape measures, for example, measure only a single dimension at a time and thus require a user to make and record/remember multiple measurements when measuring the area. It will be appreciated that taking time to make and record multiple measurements can significantly add to the overall time spent on a construction project, particularly if the project involves cutting material to fit multiple distinct areas, and thus can add to the overall cost of the project. Furthermore, tape measures are not useful for replicating a curved edge and can be cumbersome and inaccurate in replicating angled edges.

One method of cutting a material to match the size and shape of an area with arbitrarily curved and/or angled edges involves using a piece of paper or cloth to replicate the area for use as a pattern by, for example, tracing an outer edge of the paper or cloth onto the material to be cut. This, too, is time consuming because a user must first cut the paper or cloth to the size and shape of the area by, for example, laying the paper or cloth in the area, tracing the edges of the area onto the paper/cloth, and cutting out the traced portion. This method is time consuming and susceptible to inaccuracies because errors may be introduced during the tracing and cutting of the pattern as well as during the tracing and cutting of the material to cover or fill the area.

Due to the above-mentioned and other problems and disadvantages in the art, a need exists for an improved carpenter's tool that allows a carpenter to quickly and accurately prepare a material to match the size and shape of an area.

### SUMMARY OF THE INVENTION

The present invention provides an improved measuring device that does not suffer from the problems and limitations of the prior art discussed above. Particularly, the present invention provides a measuring device with an adjustable size and shape that may be adjusted to conform to a size and a shape of an area, wherein the device retains the size and shape as a pattern for cutting a material to the same size and shape as the area.

In one embodiment, the device comprises a base that includes a first elongated segment and a second elongated segment adjustably secured to the first segment so that the second segment is moveable relative to the first segment along a longitudinal axis of the base. The device further comprises an elongated cross member adjustably secured to the base so that the cross member is substantially perpendicular to the base and is moveable relative to the base along a lateral axis of the base.

In another embodiment of the invention, the device comprises a base with a groove running longitudinally along a center of the base, the base including a first fastener located proximate a first end of the base and a second fastener located proximate a second end of the base. A first elongated arm mates with the groove so that a first end of the arm is located in the groove near a middle of the base and a second end of the arm extends over the first end of the base. The arm is moveable relative to the base along the groove and includes an elongated aperture for receiving the first fastener of the base, the arm further including a fastener near the first end of the arm.

A second elongated arm also mates with the groove so that a first end of the arm is located in the groove near the middle of the base and a second end of the arm extends over the second end of the base. The second arm is also moveable relative to the base along the groove and includes an elongated aperture for receiving the second fastener of the base, the arm further including a fastener near the first end of the arm.

The device further comprises a first elongated cross member with an elongated aperture for receiving the fastener of the first arm, and a second elongated cross member with an elongated aperture for receiving the fastener of the second arm.

In another embodiment of the invention, the device comprises an elongated base with a top surface and a bottom surface, the top surface presenting a groove running longitudinally along a center of the top surface and extending from the top surface toward the bottom surface, the base including a first bolt located proximate a first end of the base and a second bolt located proximate a second end of the base, wherein each bolt extends upward from a center of the groove.

A first planar elongated arm mates with the groove so that a first end of the arm is located in the groove near a middle of the base and a second end of the arm extends over the first end of the base. The arm is moveable relative to the base along the groove and includes an elongated aperture running longitudinally along a portion of a center of the arm for receiving the first bolt of the base, wherein securing a nut to the bolt prevents the arm from moving relative to the base. The arm further includes a bolt near the first end of the arm and extending upward from the arm.

A second planar elongated arm mates with the groove so that a first end of the arm is located in the groove near the middle of the base and a second end of the arm extends over a second end of the base. The arm is moveable relative to the base along the groove and includes an elongated aperture running longitudinally along a portion of a center of the arm for receiving the second bolt of the base, wherein securing a nut to the bolt prevents the arm from moving relative to the base. The arm second arm also includes a bolt near the first end of the arm and extending upward from the arm.

The device further comprises a first planar elongated cross member with an elongated aperture running longitudinally along a center of a portion of the cross member for receiving the bolt of the first arm and guiding the movement of the cross member relative to the first arm; and a second planar elongated cross member with an elongated aperture running longitudinally along a center of a portion of the cross member for receiving the bolt of the second arm and guiding the movement of the second cross member relative to the second arm.

These and other important features of the present invention are more fully described in the section titled DETAILED DESCRIPTION OF PREFERRED EMBODIMENTS, below.

### BRIEF DESCRIPTION OF THE DRAWINGS

A preferred embodiment of the present invention is described in detail below with reference to the attached drawing figures, wherein:

FIG. 1 is an exploded perspective exploded view of a measuring device constructed in accordance with a first preferred embodiment of the invention;

FIG. 2 is a perspective view of the measuring device of FIG. 1, wherein the device is fully assembled and arms and cross members of the device are shown in a retracted position;

FIG. 3 is a perspective view of the measuring device of FIG. 1, wherein the device is fully assembled and the arms and cross members are shown in an extended position;

FIG. 4 is a perspective view of the measuring device of FIG. 1 shown measuring a window sill;

FIG. 5 is a perspective view of the measuring device of FIG. 1 shown presenting a pattern on a board to be cut to fit within the window sill of FIG. 4;

FIG. 6 is a side elevation view of the measuring device of FIG. 1, illustrating a cross section of the device;

FIG. 7 is a sectional perspective view of a measuring device constructed in accordance with a second preferred embodiment of the invention; and

FIG. 8 is a sectional perspective view of a measuring device constructed in accordance with a third preferred embodiment of the invention.

### DETAILED DESCRIPTION OF PREFERRED EMBODIMENTS

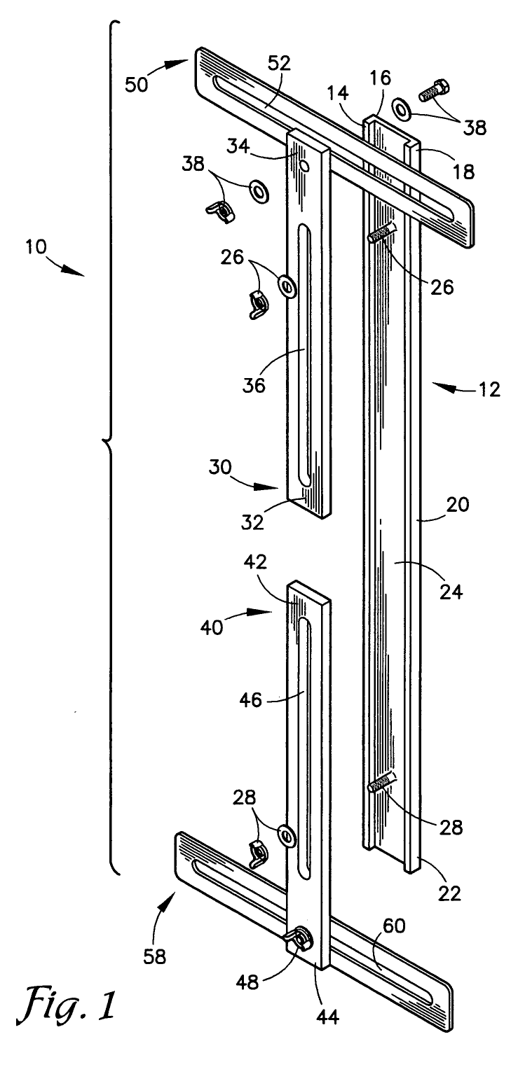

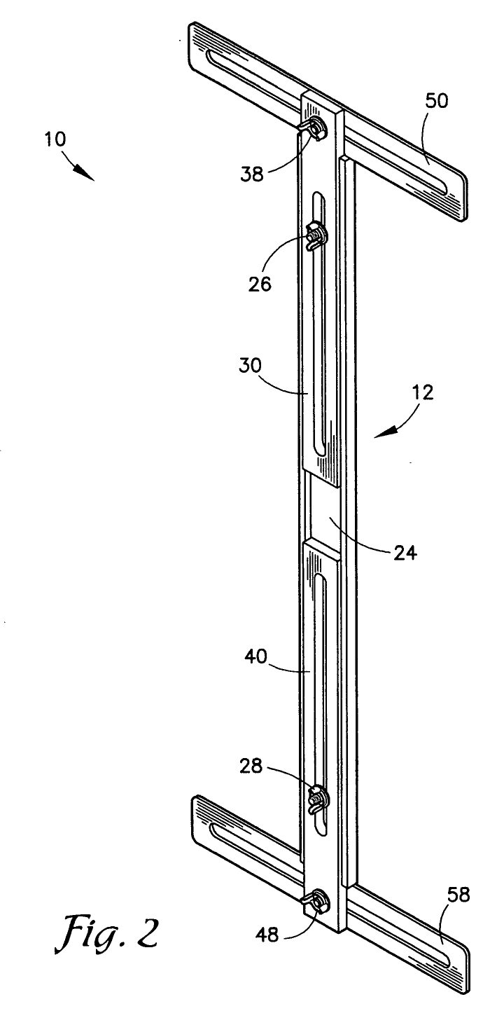

Referring initially to FIGS. 1 and 2, an exemplary measuring device employing the principles of the present invention is shown and designated generally by the reference numeral 10. The measuring device 10 generally adjusts to conform to a size and a shape of a surface area and retains the size and shape as a pattern of the area for cutting a material to cover or fill the area. The measuring device 10 comprises a base 12, a first arm 30, a second arm 40, a first cross member 50, and a second cross member 58.

The base 12 generally receives and supports the arms 30,40 and guides the arms 30,40 in their movement relative to the base 12. The illustrated base 12 is elongated and presents a top surface 14; a bottom surface 16; a first end 18; a middle 20; a second end 22; a groove 24; a first fastener 26; and a second fastener 28. The groove 24 receives at least a portion of each of the arms 30,40 and serves as a track to guide their movement relative to the base 12. The groove 24 runs longitudinally along a center of the base 12, opening on the top surface 14 and extending toward the bottom surface 16.

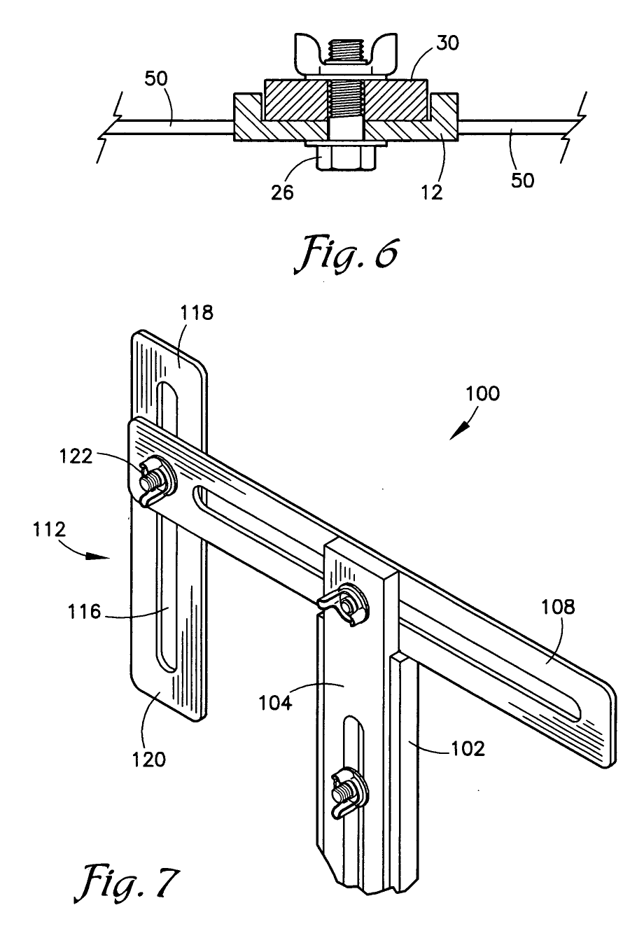

Referring also to FIG. 6, the first fastener 26 generally adjustably secures the first arm 30 to the base 12, wherein the first arm 30 is moveable relative to the base 12 when the fastener 26 is loosened and is fixed to the base 12 when the fastener 26 is tightened. The illustrated fastener 26 includes a nut and bolt combination and various washers, wherein a shank of the bolt extends through a hole in the base 12, through a substantially elongated aperture 36 in the first arm 30 (described below in detail), and receives the nut so that the nut (or a washer) contacts the first arm 30 and a head of the bolt (or a washer) contacts the bottom surface 16 of the base 12. The fastener 26 preferably includes a wing nut, as illustrated, to enable a user to loosen and tighten the fastener 26 without the use of tools. The bolt preferably passes through a hole (not shown) of the base 12, but may be integral with the base 12.

The first fastener 26 of the base 12 is located proximate the first end 18 of the base 12 so that when the fastener 26 is loosened, a portion of the first arm 30 is slidable beyond the first end 18 of the base 12 to adjust an overall length of the device 10, for example, to a length of an area to be measured. The device 10 retains the length when the fastener 26 is tightened to prevent the first arm 30 from moving relative to base 12.

The second fastener 28 is virtually identical in form and function to the first fastener 26, except that the second fastener 28 is located proximate the second end 22 of the base 12 and adjustably secures the second arm 40 to the base 12. When the fastener 28 is loosened, therefore, a portion of the second arm 40 is slidable beyond the second end 22 of the base 12 to adjust the overall length of the device 10 to a length of the area to be measured. The device 10 retains the length when the second fastener 26 is tightened to prevent the second arm 40 from moving relative to the base 12.

The first arm 30 adjustably secures to the base 12 via the first fastener 26, as explained above. The illustrated first arm 30 includes a first end 32; a second end 34; an aperture 36; and a fastener 38. The first end 32 of the arm 30 is placed proximate the middle 20 of the base 12 while the second end 34 of the arm 30 extends over the first end 18 of the base 12.

The arm 30 is shaped so that at least a portion of the arm 30 engages the groove 24 of the base 12. When the first fastener 26 is loosened, the arm 30 is movable relative to the base 12 along the groove 24. The aperture 36 is wide enough to receive the shank of the bolt of the first fastener 26 of the base 12, is substantially elongated, and runs longitudinally along a center of the arm 30. When the first fastener 26 is loosened, the arm 30 is slidable along the groove 24 of the base 12 toward the first end 18 or the middle 20 of the base 12 until the first fastener 26 contacts an end of the aperture 36. The fastener 38 secures the first cross member 50 to the first arm 30, as explained below in greater detail. The fastener 38 is located proximate the second end 34 of the first arm 30 and is substantially identical in form to the first fastener 26 and the second fastener 28 of the base 12.

The second arm 40 adjustably secures to the base 12 via the second fastener 28 to allow a user to adjust the arm 40 along a longitudinal axis of the base 12 so that a length of the device 10 conforms, for example, to a length of an area to be measured. The second arm 40 includes a first end 42; a second end 44; an aperture 46; and a fastener 48. The second arm 40 is virtually identical in form and function to the first arm 30, except that the second arm 40 is located so that the first end 42 of the arm 40 is placed proximate the middle 20 of the base 12 while the second end 44 of the arm 40 extends over the second end 22 of the base 12.

The first cross member 50 generally adjustably attaches to the first arm 30 via the fastener 38 of the first arm 30 to allow the cross member 50 to pivot and/or slide relative to the first arm 30. Pivoting or sliding the cross member 50 relative to the arm 30 allows the cross member 50 to conform, for example, to an angle and/or a depth of an edge of the area to be measured. The cross member 50 includes an aperture 52; a first end 54; and a second end 56. The aperture 52 generally receives the fastener 38 of the first arm 30 so that when the fastener 38 is loosened, the cross member 50 is moveable relative to the first arm 30, and when the fastener 38 is tightened the cross member 50 is fixed to the first arm 30. The aperture 52 is large enough to receive, for example, the shank of a bolt yet sufficiently narrow to prevent passage of a nut threaded onto the shank.

The cross member 50 does not engage a groove or similar feature on the first arm 30, therefore the cross member 50 is free to pivot about the fastener 38 of the first arm 30. Thus, the cross member 50 may pivot to conform to an edge of a surface area to be measured that is at an arbitrary angle relative to the base 12, and may further slide along the fastener 38 of the first arm 30 to conform to a depth of the edge. It will be appreciated that the first cross member 50 may also be used to extend the length of the device 10 by, for example, pivoting the cross member 50 until it is longitudinally aligned with the base 12 and sliding it away from the middle 20 of the base 12.

The second cross member 58 generally adjustably attaches to the second arm 40 via the fastener 48 of the second arm 40 to allow the cross member 58 to pivot and/or slide relative to the second arm 40. The second cross member 58 includes an aperture 60; a first end 62; and a second end 64. The second cross member 58 is virtually identical in form and function to the first cross member 50, except that the second cross member 58 attaches to the second arm 40 instead of the first arm 30 and thus can adjust to conform to a second edge of the area to be measured.

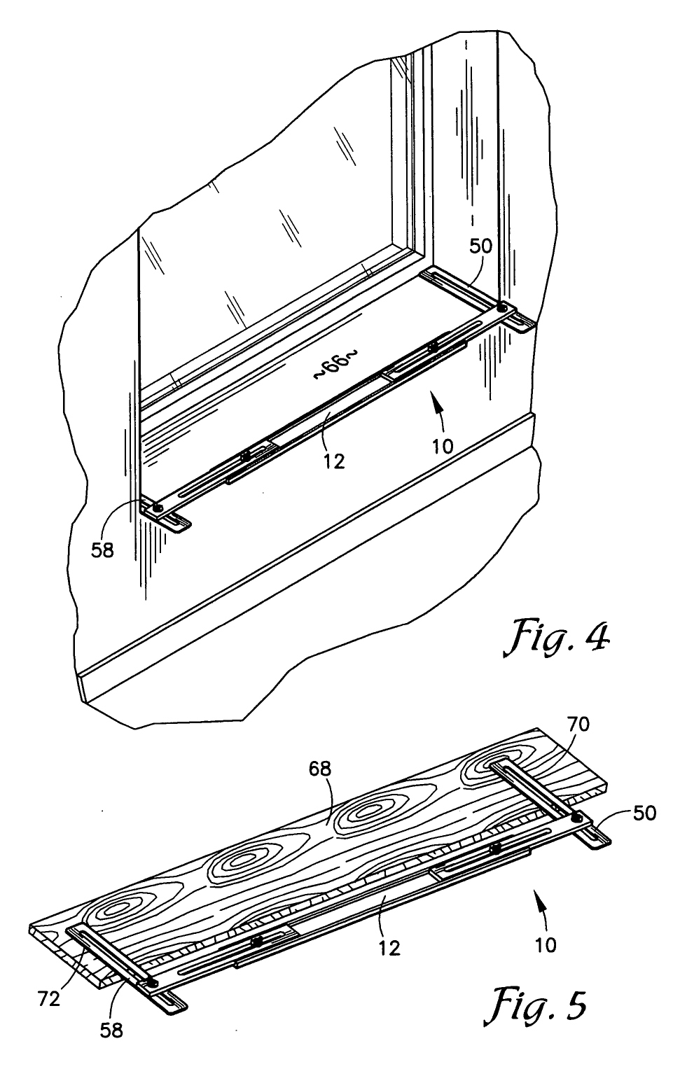

In use, a user first adjusts the device 10 to conform to a shape of an area to be measured, such as a window sill 66 as illustrated in FIG. 4. The user first adjusts a length of the device 10 to conform to a length of the window sill 66. The user adjusts the length of the device 10 by loosening the first fastener 26 and extending the first arm 30 to increase the length of the device 10 to conform to the length of the window sill 66. If the first arm 30 is fully extended and the length of the device 10 is insufficient to conform to the length of the window sill 66, the user loosens the second fastener 28 and extends the second arm 40 to further increase the length of the device 10 until it conforms to the length of the window sill 66. The first cross member 50 and/or the second cross member 58 may be used to further extend the length of the device 10 by pivoting the cross member(s) to align longitudinally with the base 12, as explained above.

When the length of the device 10 is adjusted to conform to the length of the window sill 66, the user adjusts a width of the device 10 to conform to a width of the window sill 66 by adjusting the first cross member 50 and/or the second cross member 58. The user first positions the device 10 so that a longitudinal edge of the base 12 is flush with an edge of the window sill, as illustrated in FIG. 4. The user then loosens the fastener 38 of the first arm 30 and adjusts the first cross member 50 relative to the first arm 30 so that the first cross member 50 conforms to an edge of the window sill 66 at a first end of the sill 66. The user tightens the fastener 38 so that the device 10 retains the angle and depth of the edge. The user then loosens the fastener 48 of the second arm 40 and adjusts the second cross member 58 relative to the second arm 40 so that the second cross member 58 conforms to an edge of the window sill 66 at a second end of the sill 66. The user tightens the fastener 48 of the second arm 40 so that the device 10 retains the angle and depth of the edge.

With the device 10 adjusted to conform to a size and shape of the window sill 66 and the fasteners 26,28,38,48 tightened, the device 10 may be removed from the window sill 66 and placed on a board 68 as illustrated in FIG. 5. Once the device 10 is placed on the board 68, the user traces the shape of the window sill 66 onto the board 68 by tracing a first line along an outer edge 70 of the first cross member 50 and a second line along an outer edge 72 of the second cross member 58 with a pencil or other marking device. The user completes the pattern by marking a line on the board 68 to connect an end of the first line with an end of the second line. Once the pattern of the window sill 66 is transferred to the board 68, the board 68 may be cut in the shape of the window sill 66 by cutting along the lines.

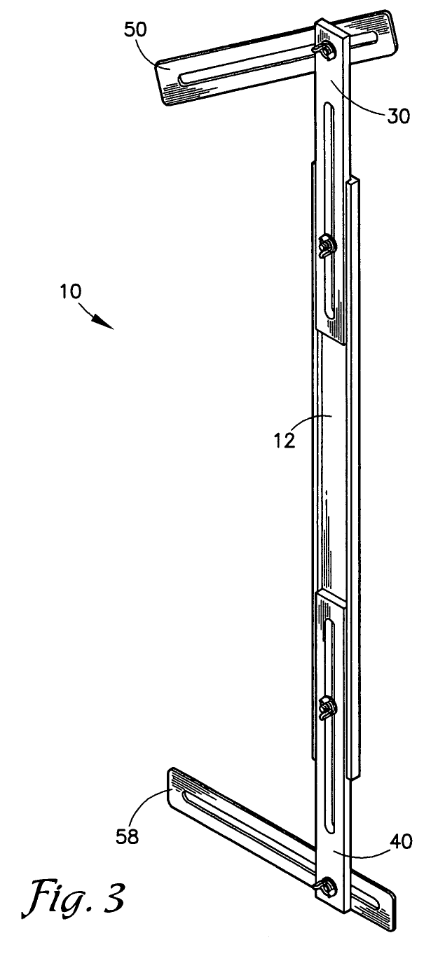

While the illustrated window sill 66 is substantially square, the measuring device 10 is useful to measure areas that are defined by edges that do not form a square and/or are not parallel. If a first edge of a window sill is not at a ninety-degree angle to a front edge of the window sill, for example, the first cross member 50 may be pivoted relative to the first arm 30 to reflect the angle of the first edge of the window sill, as illustrated in FIG. 3. In this manner, the measuring device 10 retains a pattern of not only the size but the shape of the window sill.

While the measuring device has been described as measuring a board 68 to be cut to fit within a window sill 66, it will be appreciated that the measuring device 10 is useful to measure a size and shape of any area that needs to be fitted or covered with a material. The measuring device 10 may be used, for example, to measure a size and shape of an area of a wall or a ceiling in which sheet rock is to be hung.

Referring now to FIG. 7, an exemplary measuring device employing the principles of the present invention and constructed according to a second preferred embodiment is shown and designated generally by the reference numeral 100. The measuring device 100 is similar in form and function to the measuring device 10 and includes, for example, a base 102; a first arm 104; a second arm 106 (not shown); a first cross member 108; and a second cross member 110 (not shown). These elements are substantially identical to analogous elements of the device 10. The cross members 108,110 of the measuring device 100, however, include fasteners 122, 124 and the measuring device 100 further includes a first end member 112 and a second end member 114 (not shown).

The first end member 112 generally adjustably attaches to the first cross member 108 via fastener 122 of the first cross member 108 to allow the end member 112 to pivot and/or slide relative to the first cross member 108. Pivoting or sliding the end member 112 relative to the cross member 108 allows the device 10 conform, for example, to a length and an angle of an edge of the area to be measured. The end member 112 includes an aperture 116; a first end 118; and a second end 120. The aperture 116 generally receives the fastener 122 of the first cross member 108 so that when the fastener 122 is loosened, the end member 112 is moveable relative to the first cross member 108, and when the fastener 122 is tightened the end member 112 is fixed to the first cross member 108. The aperture 116 is large enough to receive, for example, the shank of a bolt yet sufficiently narrow to prevent passage of a nut threaded onto the shank. The aperture 116 is substantially elongated so that when the fastener 114 is loosened, the end member 112 slides relative to the first cross member 108.

The end member 112 does not engage a groove or similar feature on the first cross member 108, therefore the end member 50 is free to pivot about the fastener 114 of the first cross member 108. Thus, the end member 112 may pivot to conform to an edge of the area to be measured that is at an angle to the cross member 108, and may further slide along the fastener 122 of the first cross member 108 to conform to a depth of the edge. It will be appreciated that the illustrated device 100 is illustrative only, and that the principles of the present invention may be employed in a measuring device that includes multiple end members, including a plurality of serially-linked members that form one or more articulating arms.

The measuring device 100 is used in a manner substantially similar to that of the measuring device 10, described above, except that the measuring device 100 is capable of conforming to a shape of an area defined by more sides, such as a trapezoidal-shaped area or an area with an array of non-parallel sides. This may be particularly useful, for example, to cut a board to fit within a sill of a bay window, or to create pattern of a multi-sided obstacle in a wall around which sheet rock will be hung.

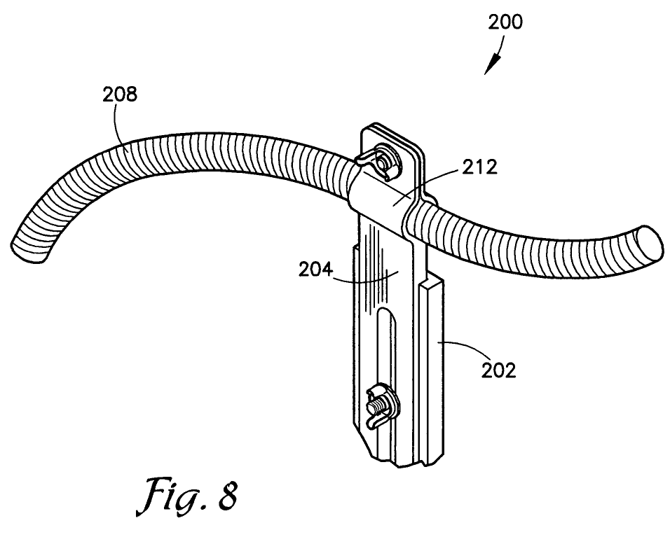

Referring now to FIG. 8, an exemplary measuring device employing the principles of the present invention and constructed according to a third preferred embodiment is shown and designated generally by the reference numeral 200. The measuring device 200 is similar in form and function to the measuring device 10 and includes, for example, a base 202, a first arm 204, and a second arm 206 (not shown) that are substantially similar to the base 12, the first arm 30, and the second arm 40 of the measuring device 10, described above. The measuring device 200, however, further includes a first flexible cross member 208 and a second flexible cross member 210 (not shown).

The first flexible cross member 206 generally adjustably attaches to the first arm 204 and conforms to one or more arbitrary curves of an edge of an area to be measured. The flexible cross member 208 adjustably attaches to the first arm 204 via an adjustable gripping mechanism 212 of the first arm 204 that includes a clamp structure braced with a bolt and wingnut combination, as illustrated. The flexible cross member 208 is preferably constructed of a malleable material, such as a polymer or elastomer capable of retaining its shape and enduring repeated deformation and re-shaping. The second cross member 210 is substantially identical to the first cross member 208, except that the second cross member 210 is adjustably attached to the second arm 206.

The measuring device 200 is used in a manner substantially similar to that of the measuring device 10, described above, except that the measuring device 200 is capable of measuring an area with one or more arbitrarily curved edges. The first arm 204 and/or the second arm 206 are adjusted so that a length of the device 200 conforms to a length of an area to be measured, as described in detail above in relation to the device 10. The first flexible cross member 208 is then adjusted to conform to a shape and/or a depth of a first edge of the area to be measured. The flexible cross member 208 is adjusted by loosening the gripping mechanism 212 and sliding the cross member 208 relative to the arm 204 so that the cross member 208 conforms to a depth of the first edge. The cross member 208 may also be adjusted by bending it to conform to one or more arbitrary curves in the first edge. The second flexible cross member 210 is similarly adjusted to conform to a size and/or depth of a second edge of the area to be measured.

Although the invention has been described with reference to the preferred embodiments illustrated in the attached drawings, it is noted that equivalents may be employed and substitutions made herein without departing from the scope of the invention as recited in the claims. It will be appreciated, for example, that the first and second arms of the measuring device may be pivotally attached to the base and/or may include telescoping segments to further extend the reach of the measuring device.

Having thus described the preferred embodiment of the invention, what is claimed as new and desired to be protected by Letters Patent includes the following:

1. A measuring device comprising:
a base including
a first elongated segment, and
a second elongated segment adjustably secured to the first segment so that the second segment is moveable relative to the first segment along a longitudinal axis of the base; and
an elongated cross member adjustably secured to the base so that the cross member is substantially perpendicular to the base and is moveable relative to the base along a lateral axis of the base.

2. The measuring device as set forth in claim 1, wherein the elongated cross member is adjustably secured to an end of the second elongated segment distal the first elongated segment.

3. The measuring device as set forth in claim 2, wherein the base further includes a third elongated segment adjustably secured to the first segment so that the third segment is moveable relative to the first segment along the longitudinal axis of the base.

4. The measuring device as set forth in claim 3, wherein the first and second elongated segments of the base each includes an elongated aperture for receiving a fastener.

5. The measuring device as set forth in claim 3, further comprising a second elongated cross member adjustably secured to an end of the third elongated segment distal the first elongated segment.

6. The measuring device as set forth in claim 5, wherein the first and second cross members each include an elongated aperture for receiving a fastener.

7. The measuring device as set forth in claim 5, wherein the first elongated segment includes a longitudinal groove so that a portion of the second segment and a portion of the third segment mate with the groove.

8. The measuring device as set forth in claim 7, wherein the second and third elongated segments of the base are each adjustably secured to the first segment of the base by a fastener that includes a bolt and a wingnut.

9. The measuring device as set forth in claim 7, further comprising a first end member adjustably secured to an end of the first cross member distal the second elongated segment of the base.

10. The measuring device as set forth in claim 9, further comprising a second end member adjustably secured to an end of the second cross member distal the third elongated segment of the base.

11. The measuring device as set forth in claim 10, wherein the first end member and the second end member each include an elongated aperture for receiving a fastener.

12. The measuring device as set forth in claim 1, wherein the elongated cross member is flexible.

13. The measuring device as set forth in claim 12, wherein the elongated cross member is adjustably secured to an end of the second elongated segment distal the first elongated segment.

14. The measuring device as set forth in claim 13, further comprising a second elongated cross member adjustably secured to an end of the third elongated segment distal the first elongated segment.

15. The measuring device as set forth in claim 14, further comprising a second flexible elongated cross member adjustably secured to an end of the third elongated segment distal the first elongated segment.

16. The measuring device as set forth in claim 15, wherein the first and second elongated segments of the base each includes an elongated aperture for receiving a fastener.

17. The measuring device as set forth in claim 15, wherein the first cross member is adjustably secured to the second elongated segment with a fastener that includes a bolt and a wingnut, and wherein the secodn cross member is adjustably secured to the third elongated segment with a fastener that includes a bolt and a wingnut.

18. The measuring device as set forth in claim 17, wherein the first elongated segment includes a longitudinal groove so that a portion of the second segment and a portion of the third segment mate with the groove.

19. The measuring device as set forth in claim 18, wherein the second and third elongated segments of the base are each adjustably secured to the first segment of the base by a fastener that includes a bolt and wingnut.

20. A measuring device comprising:
a base with a groove running longitudinally along a center of the base, the base including a first fastener located proximate a first end of the base and a second fastener located proximate a second end of the base;
a first elongated arm that mates with the groove so that a first end of the arm is located in the groove near a middle of the base and a second end of the arm extends over the first end of the base, the arm being moveable relative to the base along the groove and including an elongated aperture for receiving the first fastener of the base, the arm further including a fastener near the first end of the arm;
a second elongated arm that mates with the groove so that a first end of the arm is located in the groove near the middle of the base and a second end of the arm extends over the second end of the base, the arm being moveable relative to the base along the groove and including an elongated aperture for receiving the second fastener of the base, the arm further including a fastener near the first end of the arm;
a first elongated cross member with an elongated aperture for receiving the fastener of the first arm; and
a second elongated cross member with an elongated aperture for receiving the fastener of the second arm.

21. The measuring device as set forth in claim 20, further comprising a first end member adjustably secured to the second end of the first elongated arm.

22. The measuring device as set forth in claim 21, further comprising a second end member adjustably secured to the second end of the second elongated arm.

23. A measuring device comprising:
an elongated base with a top surface and a bottom surface, the top surface presenting a groove running longitudinally along a center of the top surface and extending from the top surface toward the bottom surface, the base including a first bolt located proximate a first end of the base and a second bolt located proximate a second end of the base, wherein each bolt extends upward from a center of the groove;
a first planar elongated arm that mates with the groove so that a first end of the arm is located in the groove near a middle of the base and a second end of the arm extends over the first end of the base, the arm being moveable relative to the base along the groove and including an elongated aperture running longitudinally along a portion of a center of the arm for receiving the first bolt of the base, wherein securing a nut to the bolt prevents the arm from moving relative to the base, the arm further including a bolt near the first end of the arm and extending upward from the arm;
a second planar elongated arm that mates with the groove so that a first end of the arm is located in the groove near the middle of the base and a second end of the arm extends over a second end of the base, the arm being moveable relative to the base along the groove and including an elongated aperture running longitudinally along a portion of a center of the arm for receiving the second bolt of the base, wherein securing a nut to the bolt prevents the arm from moving relative to the base, the arm further including a bolt near the first end of the arm and extending upward from the arm;
a first planar elongated cross member with an elongated aperture running longitudinally along a center of a portion of the cross member for receiving the bolt of the first arm and guiding the movement of the cross member relative to the first arm; and
a second planar elongated cross member with an elongated aperture running longitudinally along a center of a portion of the cross member for receiving the bolt of the second arm and guiding the movement of the second cross member relative to the second arm.
